(19) United States
(12) Patent Application Publication
(10) Pub. No.: US 2026/0354494 A1
(43) Pub. Date: Nov. 12, 2026

(54) AEROSOL GENERATING DEVICE AND OPERATING METHOD THEREFOR

(71) Applicant: KT&G CORPORATION, Daejeon (KR)

(72) Inventors: Yong Hwan KIM, Gyeonggi-do (KR); Seok Su JANG, Daejeon (KR); Young Bum KWON, Gyeonggi-do (KR); Dong Sung KIM, Seoul (KR); Hwi Kyeong AN, Seoul (KR)

(73) Assignee: KT&G CORPORATION, Daejeon (KR)

(21) Appl. No.: 19/123,342

(22) PCT Filed: Jul. 8, 2024
(86) PCT No.: PCT/KR2024/009712

§ 371 Date: Apr. 22, 2025

(30) Foreign Application Priority Data
Jul. 13, 2023 (KR) 10-2023-0091353
Sep. 14, 2023 (KR) 10-2023-0122610

(51) Int. Cl. A24F 40/57; A24F 40/20; A24F 40/53

(52) U.S. Cl. CPC A24F 40/57; A24F 40/20; A24F 40/53

(57) ABSTRACT

An aerosol generating device according to an embodiment includes a heater configured to heat a cigarette, a temperature sensor configured to measure a temperature of the heater, and a controller configured to calculate a temperature rise time of the cigarette by using the temperature sensor and compare the calculated temperature rise time of the cigarette with a preset threshold value to determine a humidity state of the cigarette. The controller supplies power to the heater according to a compensation profile when the temperature rise time is at the threshold value or more, the compensation profile including a preheating section including a temperature lowering section to condense moisture within the cigarette and a temperature re-rising section to vaporize the condensed moisture.

### TECHNICAL FIELD

The present disclosure relates to an aerosol generating device and an operating method thereof, and more particularly to, an aerosol generating device capable of distinguishing between a regular cigarette and an over-wet cigarette based on a heating rate and providing a temperature profile corresponding to the state of a cigarette, and an operating method of the aerosol generating device.

### BACKGROUND ART

Recently, the demand for smoking methods replacing general cigarettes has increased. For example, there is an increasing demand for a method of generating aerosols by heating an aerosol generating material in cigarettes, rather than by burning cigarettes. Accordingly, studies have been actively conducted on a heating-type cigarette or a heating-type aerosol generating device.

Moisture has a higher specific heat than air, and a heat capacity thereof is greater than that of air at a same temperature. Therefore, when a user inhales aerosols with a high moisture content, the user may feel hotter than when inhaling air having a same temperature. Accordingly, when an over-wet cigarette is heated, a section for adjusting a temperature is included to prevent the risk of burns due to an increased temperature of mainstream smoke, and thus, a longer preheating time than a regular cigarette is required.

### DISCLOSURE OF INVENTION

### Technical Problem

The present disclosure provides an aerosol generating device including a temperature profile capable of generating a suitable temperature of mainstream smoke for smoking and reducing a preheating time, when heating an over-wet cigarette, and an operating method of the aerosol generating device.

The technical problems to be solved by the embodiments are not limited to the above-described problems, and problems that are not mentioned will be clearly understood by those of ordinary skill in the art from the present disclosure and the accompanying drawings.

### Solution to Problem

An aerosol generating device according to an embodiment includes a heater configured to heat a cigarette, a temperature sensor configured to measure a temperature of the heater, and a controller configured to calculate a temperature rise time of the cigarette by using the temperature sensor and compare the calculated temperature rise time of the cigarette with a preset threshold value to determine a humidity state of the cigarette. The controller supplies power to the heater according to a compensation profile when the temperature rise time is at the threshold value or more, the compensation profile including a preheating section including a temperature lowering section to condense moisture within the cigarette and a temperature re-rising section to vaporize the condensed moisture.

An operating method of an aerosol generating device according to an embodiment includes heating a cigarette by a heater, measuring a temperature of the heater by a temperature sensor, calculating a temperature rise time of the cigarette by using the temperature sensor and comparing the calculated temperature rise time with a preset threshold value to determine a humidity state of the cigarette, and operating the heater with a temperature profile corresponding to the determined humidity state of the cigarette. The determining of the humidity state of the cigarette includes determining the cigarette as a regular cigarette when the temperature rise time is less than the threshold value, and determining the cigarette as an over-wet cigarette when the temperature rise time is at the threshold value or more, and the operating of the heater includes supplying power to the heater according to a compensation profile when the temperature rise time is at the threshold value or more, the compensation profile including a preheating section including a temperature lowering section to condense moisture within the cigarette and a temperature re-rising section to vaporize the condensed moisture.

### Advantageous Effects of Invention

An aerosol generating device and an operating method thereof according to various embodiments of the present disclosure may provide a temperature profile capable of generating a suitable temperature of mainstream smoke for smoking and reducing a preheating time, when heating an over-wet cigarette.

Technical problems to be solved by the embodiments are not limited to the above-described problems, and problems that are not mentioned will be clearly understood by those of ordinary skill in the art from the disclosure and the accompanying drawings.

### BRIEF DESCRIPTION OF DRAWINGS

FIGS. 1 through 3 are diagrams showing examples in which a cigarette is inserted into an aerosol generating device.

FIGS. 4 and 5 are diagrams showing examples of cigarettes.

FIG. 6 is a block diagram of an aerosol generating device according to another embodiment.

FIG. 7A is a perspective view showing the exterior of an aerosol generating device according to an embodiment of the present disclosure.

FIG. 7B is a perspective view showing an operating state in which some components are separated from the aerosol generating device according to the embodiment shown in FIG. 7A.

FIG. 8 shows an example to describe a basic temperature profile of an aerosol generating device.

FIG. 9 shows an example to describe a first compensation profile of an aerosol generating device.

FIG. 10 shows an example to describe a second compensation profile for an over-wet cigarette, according to another embodiment to describe an effect of the first compensation profile shown in FIG. 9.

FIG. 11A is a flowchart illustrating an operating method of an aerosol generating device according to an embodiment, in consideration of a humidity state of a cigarette.

FIG. 11B is a flowchart illustrating an operating method of an aerosol generating device according to another embodiment, in consideration of a humidity state of a cigarette.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof. Hereinafter, the present disclosure will now be described more fully with reference to the accompanying drawings, in which embodiments of the present disclosure are shown such that one of ordinary skill in the art may easily work the present disclosure. The present disclosure can, however, be embodied in many different forms and should not be construed as being limited to the embodiments set forth herein.

Hereinafter, embodiments of the present disclosure will be described in detail with reference to the drawings.

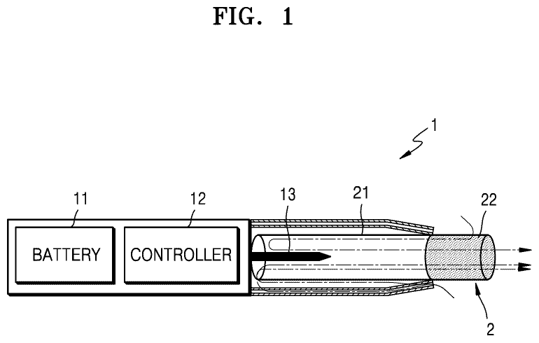

FIGS. 1 through 3 are diagrams showing examples in which a cigarette is inserted into an aerosol generating device.

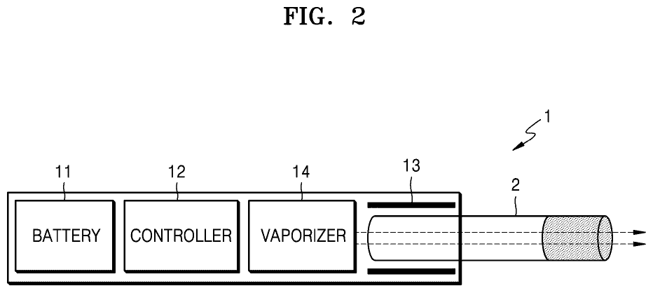

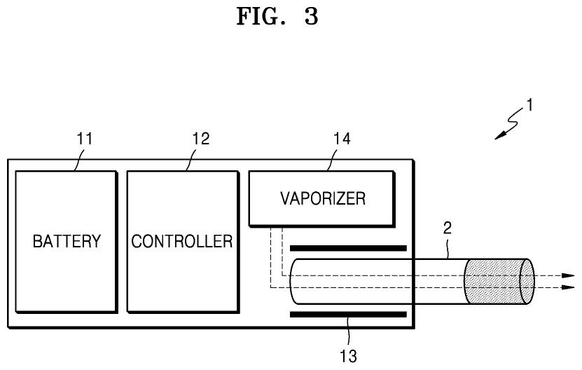

Referring to FIG. 1, the aerosol generating device 1 may include a battery 11, a controller 12, and a heater 13. Referring to FIGS. 2 and 3, the aerosol generating device 1 may further include a vaporizer 14. Also, the cigarette 2 may be inserted into an inner space of the aerosol generating device 1.

FIGS. 1 through 3 illustrate components of the aerosol generating device 1, which are related to the present embodiment. Therefore, it will be understood by one of ordinary skill in the art related to the present embodiment that other general-purpose components may be further included in the aerosol generating device 1, in addition to the components illustrated in FIGS. 1 through 3.

Also, FIGS. 2 and 3 illustrate that the aerosol generating device 1 includes the heater 13. However, as necessary, the heater 13 may be omitted.

FIG. 1 illustrates that the battery 11, the controller 12, and the heater 13 are arranged in series. Also, FIG. 2 illustrates that the battery 11, the controller 12, the vaporizer 14, and the heater 13 are arranged in series. Also, FIG. 3 illustrates that the vaporizer 14 and the heater 13 are arranged in parallel. However, the internal structure of the aerosol generating device 1 is not limited to the structures illustrated in FIGS. 1 through 3. In other words, according to the design of the aerosol generating device 1, the battery 11, the controller 12, the heater 13, and the vaporizer 14 may be differently arranged.

When the cigarette 2 is inserted into the aerosol generating device 1, the aerosol generating device 1 may operate the heater 13 and/or the vaporizer 14 to generate aerosol. The aerosol generated by the heater 13 and/or the vaporizer 14 is delivered to a user by passing through the cigarette 2.

As necessary, even when the cigarette 2 is not inserted into the aerosol generating device 1, the aerosol generating device 1 may heat the heater 13.

The battery 11 may supply power to be used for the aerosol generating device 1 to operate. For example, the battery 11 may supply power to heat the heater 13 or the vaporizer 14, and may supply power for operating the controller 12. Also, the battery 11 may supply power for operations of a display, a sensor, a motor, etc. mounted in the aerosol generating device 1.

The controller 12 may generally control operations of the aerosol generating device 1. In detail, the controller 12 may control not only operations of the battery 11, the heater 13, and the vaporizer 14, but also operations of other components included in the aerosol generating device 1. Also, the controller 12 may check a state of each of the components of the aerosol generating device 1 to determine whether or not the aerosol generating device 1 is able to operate.

The controller 12 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 13 may be heated by the power supplied from the battery 11. For example, when the cigarette 2 is inserted into the aerosol generating device 1, the heater 13 may be located outside the cigarette 2. Thus, the heated heater 13 may increase a temperature of an aerosol generating material in the cigarette 2.

The heater 13 may include an electro-resistive heater. For example, the heater 13 may include an electrically conductive track, and the heater 13 may be heated when currents flow through the electrically conductive track. However, the heater 13 is not limited to the example described above and may include all heaters which may be heated to a desired temperature. Here, the desired temperature may be pre-set in the aerosol generating device 1 or may be set by a user.

As another example, the heater 13 may include an induction heater. In detail, the heater 13 may include an electrically conductive coil for heating an cigarette in an induction heating method, and the cigarette may include a susceptor which may be heated by the induction heater.

For example, the heater 13 may include a tube-type heating element, a plate-type heating element, a needle-type heating element, or a rod-type heating element, and may heat the inside or the outside of the cigarette 2, according to the shape of the heating element.

Also, the aerosol generating device 1may include a plurality of heaters 13. Here, the plurality of heaters 13 may be inserted into the cigarette 2 or may be arranged outside the cigarette 2. Also, some of the plurality of heaters 13 may be inserted into the cigarette 2 and the others may be arranged outside the cigarette 2. In addition, the shape of the heater 13 is not limited to the shapes illustrated in FIGS. 1 through 3 and may include various shapes.

The vaporizer 14 may generate aerosol by heating a liquid composition and the generated aerosol may pass through the cigarette 2 to be delivered to a user. In other words, the aerosol generated via the vaporizer 14 may move along an air flow passage of the aerosol generating device 1 and the air flow passage may be configured such that the aerosol generated via the vaporizer 14 passes through the cigarette 2 to be delivered to the user.

For example, the vaporizer 14 may include a liquid storage, a liquid delivery element, and a heating element, but it is not limited thereto. For example, the liquid storage, the liquid delivery element, and the heating element may be included in the aerosol generating device 1 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 14 or may be formed integrally with the vaporizer 14.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14 may be referred to as a cartomizer or an atomizer, but it is not limited thereto.

The aerosol generating device 1may further include general-purpose components in addition to the battery 11, the controller 12, the heater 13, and the vaporizer 14. For example, the aerosol generating device 1may include a display capable of outputting visual information and/or a motor for outputting haptic information. Also, the aerosol generating device 1 may include at least one sensor (a puff sensor, a temperature sensor, an cigarette insertion detecting sensor, etc.). Also, the aerosol generating device 1 may be formed as a structure that, even when the cigarette 2 is inserted into the aerosol generating device 1, may introduce external air or discharge internal air.

Although not illustrated in FIGS. 1 through 3, the aerosol generating device land an additional cradle may form together a system. For example, the cradle may be used to charge the battery 11 of the aerosol generating device 1. Alternatively, the heater 13 may be heated when the cradle and the aerosol generating device 1 are coupled to each other.

The cigarette 2 may be similar to a general combustive cigarette. For example, the cigarette 2 may be divided into a first portion including an aerosol generating material and a second portion including a filter, etc. Alternatively, the second portion of the cigarette 2 may also include an aerosol generating material. For example, an aerosol generating material made in the form of granules or capsules may be inserted into the second portion.

The entire first portion may be inserted into the aerosol generating device 1, and the second portion may be exposed to the outside. Alternatively, only a portion of the first portion may be inserted into the aerosol generating device 1, or the entire first portion and a portion of the second portion may be inserted into the aerosol generating device 1. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol generating device 1. For example, opening and closing of the air passage and/or a size of the air passage formed in the aerosol generating device 1 may be adjusted by the user. Accordingly, the amount and the quality of smoking may be adjusted by the user. As another example, the external air may flow into the cigarette 2 through at least one hole formed in a surface of the cigarette 2.

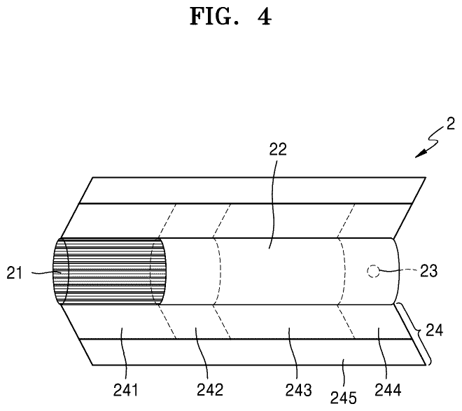

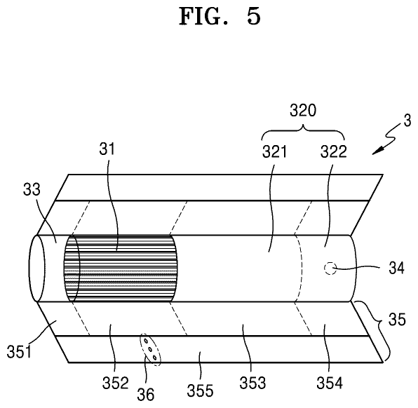

Hereinafter, examples of the cigarette 2 are described with reference to FIGS. 4 and 5.

FIGS. 4 and 5 are diagrams showing examples of cigarettes.

Referring to FIG. 4, the cigarette 2 includes a tobacco rod 21 and a filter rod 22. FIG. 4 illustrates that the filter rod 22 includes a single segment, but is not limited thereto. In other words, the filter rod 22 may include a plurality of segments. For example, the filter rod 22 may include a segment configured to cool aerosols and a segment configured to filter a certain component included in the aerosols. Also, according to necessity, the filter rod 22 may further include at least one segment configured to perform other functions.

The diameter of the cigarette 2 may be within a range of 5 mm to 9 mm, and the length of the cigarette 2 may be about 48 mm, but are not limited thereto. For example, the length of the tobacco rod 21 may be about 12 mm, the length of a first segment of the filter rod 22 may be about 10 mm, the length of a second segment of the filter rod 22 may be about 14 mm, and the length of a third segment of the filter rod 22 may be about 12 mm, but are not limited thereto.

The cigarette 2 may be packaged via at least one wrapper 24. The wrapper 24 may have at least one hole through which external air may be introduced or internal air may be discharged. For example, the cigarette 2 may be packaged via one wrapper 24. As another example, the cigarette 2 may be doubly packaged via at least two wrappers 24. For example, the tobacco rod 21 may be packaged by a first wrapper 241, and the filter rod 22 may be packaged by wrappers 242, 243, and 244. Also, the entire cigarette 2 may be repackaged via a single wrapper 245. When the filter rod 22 includes a plurality of segments, the plurality of segments may be packaged via the wrappers (i.e., 242, 243, and 244) respectively.

The first wrapper 241 and a second wrapper 242 may be made of general filter papers. For example, the first wrapper 241 and the second wrapper 242 may be porous or non-porous papers. Also, the first wrapper 241 and the second wrapper 242 may be made of oil-resistant paper and/or aluminum composite packaging material.

A third wrapper 243 may be made of hard paper. For example, the basis weight of the third wrapper 243 may be within a range of 88 g/m² to 96 g/m², and may preferably be within a range of 90 g/m² to 94 g/m². In addition, the thickness of the third wrapper 243 may be within a range of 120 μm to 130 μm, and may preferably be 125 μm.

A fourth wrapper 244 may be made of an oil-resistant hard paper. For example, the basis weight of the fourth wrapper 244 may be within a range of 88 g/m² to 96 g/m², and may preferably be within a range of 90 g/m² to 94 g/m². Also, the thickness of the fourth wrapper 244 may be within a range of 120 μm to 130 μm, and may preferably be 125 μm.

A fifth wrapper 245 may be made of sterile paper (MFW). Here, the sterile paper (MFW) refers to a paper specially manufactured to have improved tensile strength, water resistance, and smoothness compared to a regular paper. For example, the basis weight of the fifth wrapper 245 may be within a range of 57 g/m² to 63 g/m², and may preferably be 60 g/m². Also, the thickness of the fifth wrapper 245 may be within a range of 64 μm to 70 μm, and may preferably be 67 μm.

The fifth wrapper 245 may have a certain material added therein. Herein, silicon may be used as an example of the certain material, but is not limited thereto. For example, silicon has characteristics such as heat resistance with little change with temperature, oxidation resistance that does not oxidize, resistance to various drugs, water repellency, electrical insulation, or the like. However, even when silicon is not used, any material having the above-described characteristics may be applied (or coated) to the fifth wrapper 245 without limitation.

The fifth wrapper 245 may prevent the cigarette 2 from burning. For example, when the tobacco rod 21 is heated by the heater 13, the cigarette 2 may be burnt. In detail, when the temperature rises above the ignition point of any one of materials included in the tobacco rod 21, the cigarette 2 may be burnt. In this case, because the fifth wrapper 245 includes a non-combustible material, burning of the cigarette 2 may be prevented.

Also, the fifth wrapper 245 may prevent the aerosol generating device 1 from being contaminated by materials generated in the cigarette 2. Liquid materials may be generated in the cigarette 2 by a user's puff. For example, liquid materials (for example, moisture or the like) may be generated by cooling aerosols generated in the cigarette 2 by external air. As the fifth wrapper 245 packages the cigarette 2, the liquid materials generated in the cigarette 2 may be prevented from leaking out from the cigarette 2.

The tobacco rod 21 includes an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. In addition, the tobacco rod 21 may be surrounded by a heat conductive material. For example, the heat conductive material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by an induction heater. Here, although not illustrated in the drawings, the tobacco rod 21 may further include an additional susceptor, in addition to the heat conductive material surrounding the tobacco rod 21.

The filter rod 22 may include a cellulose acetate filter. The shape of the filter rod 22 is not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

A first segment of the filter rod 22 may include a cellulose acetate filter. For example, the first segment may include a tube-type structure including a hollow inside. When the heater 13 is inserted by the first segment, an internal material of the tobacco rod 21 may be prevented from being pushed back, and a cooling effect of aerosols may be generated. The diameter of the hollow included in the first segment may be an appropriate diameter within a range of 2 mm to 4.5 mm, but is not limited thereto.

The length of the first segment may be an appropriate length within a range of 4 mm to 30 mm, but is not limited thereto. Preferably, the length of the first segment may be 10 mm, but is not limited thereto.

The hardness of the first segment may be controlled by adjusting the content of plasticizer when manufacturing the first segment. In addition, the first segment may be manufactured by inserting a structure, such as a film or a tube of the same of different materials, into the inside of the first segment (for example, the hollow).

A second segment of the filter rod 22 cools aerosols generated by the heater 13 heating the tobacco rod 21. Accordingly, a user may puff the aerosols cooled to a suitable temperature.

The length or diameter of the second segment may be variously determined according to the shape of the cigarette 2. For example, the length of the second segment may be suitably used within a range of 7 mm to 20 mm. Preferably, the length of the second segment may be about 14 mm, but is not limited thereto.

The second segment may be manufactured weaving polymer fibers. In this case, a flavored liquid may also be applied to the fibers including polymers. Alternatively, the second segment may also be manufactured by weaving together a separate fiber applied with a flavored liquid and a fiber including polymers. Alternatively, the second segment may be formed by a crimped polymer sheet.

For example, the polymer may be made of a material selected from a group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed by woven polymer fibers or crimped polymer sheets, the second segment may include one or multiple channels extending in a longitudinal direction. Here, the channel refers to a passage through which a gas (e.g., air or aerosol) passes.

For example, the second segment including crimped polymer sheets may be formed from a material having a thickness of between about 5 μm to about 300 μm, for example, between about 10 μm to about 250 μm. Also, the total surface area of the second segment may be between about 300 mm²/mm to about 1000 mm²/mm. Also, the second segment may be formed from a material having a specific surface area between about 10 mm²/mg to about 100 mm²/mg.

The second segment may include a thread containing a volatile flavor component. Here, the volatile flavor component may be menthol, but is not limited thereto. For example, the thread may be filled with a sufficient amount of menthol to provide the second segment with 1.5 mg or more of menthol.

A third segment of the filter rod 22 may include a cellulose acetate filter. The length of the third segment may be suitably used within a range of 4 mm to 20 mm. For example, the length of the third segment may be about 12 mm, but is not limited thereto.

In a process of manufacturing the third segment, the third segment may be manufactured by spraying a flavored liquid onto the third segment to generate a flavor. Alternatively, a separate fiber applied with a flavored liquid may be inserted into the inside of the third segment. Aerosols generated in the tobacco rod 21 are cooled as passing through the second segment of the filter rod 22, and the cooled aerosols are delivered to the user through the third segment. Accordingly, when a flavored element is added to the third segment, an effect of increasing the persistence of flavor delivered to the user may occur.

Also, the filter rod 22 may include at least one capsule 23. Here, the capsule 23 may generate a flavor or aerosols. For example, the capsule 23 may have a structure in which a liquid including a flavoring material is wrapped with a film. The capsule 23 may have a spherical or cylindrical shape, but is not limited thereto.

Referring to FIG. 5, a cigarette 3 may further include a front-end plug 33. The front-end plug 33 may be located on a side of a tobacco rod 31, the side facing a filter rod 32. The front-end plug 33 may prevent the tobacco rod 31 from being detached outwards and prevent a liquefied aerosol from flowing into the aerosol generating device 1 (FIGS. 1 through 3) from the tobacco rod 31, during smoking.

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

The diameter and entire length of the cigarette 3 may correspond to the diameter and entire length of the cigarette 2 of FIG. 2. For example, the length of the front-end plug 33 may be about 7 mm, the length of the tobacco rod 31 may be about 15 mm, the length of the first segment 321 may be about 12 mm, and the length of the second segment 322 may be about 14 mm, but are not limited thereto.

The cigarette 3 may be packaged via at least one wrapper 35. The wrapper 35 may have at least one hole through which external air may be introduced or internal air may be discharged. For example, the front-end plug 33 may be packaged via a first wrapper 351, the tobacco rod 31 may be packaged via a second wrapper 352, the first segment 321 may be packaged via a third wrapper 353, and the second segment 322 may be packaged via a fourth wrapper 354. Also, the entire cigarette 3 may be repackaged via a fifth wrapper 355.

Also, the fifth wrapper 355 may include at least one through hole 36. For example, the through hole 36 may be formed in an area surrounding the tobacco rod 31, but is not limited thereto. The through hole 36 may be configured to transmit heat generated by the heater 13 illustrated in FIGS. 2 and 3 to the inside of the tobacco rod 31.

Also, the second segment 322 may include at least one capsule 34. Here, the capsule 34 may generate a flavor or aerosols. For example, the capsule 34 may have a structure in which a liquid including a flavoring material is wrapped with a film. The capsule 34 may have a spherical or cylindrical shape, but is not limited thereto.

The first wrapper 351 may be formed by coupling a metal foil, such as aluminum foil, to a general filter paper. For example, the entire thickness of the first wrapper 351 may be within a range of 45 μm to 55 μm, and may preferably be 50.3 μm. Also, the thickness of the metal foil of the first wrapper 351 may be within a range of 6 μm to 7 μm, and may preferably be 6.3 μm. In addition, the basis weight of the first wrapper 351 may be within a range of 50 g/m² to 55 g/m², and may preferably be 53 g/m².

The second wrapper 352 and the third wrapper 353 may be made of general filter papers. For example, the second wrapper 352 and the third wrapper 353 may be porous or non-porous papers.

For example, the porosity of the second wrapper 352 may be 35000 CU, but is not limited thereto. Also, the thickness of the second wrapper 352 may be within a range of 70 μm to 80 μm, and may preferably be 78 μm. In addition, the basis weight of the second wrapper 352 may be within a range of 20 g/m² to 25 g/m², and may preferably be 23.5 g/m².

For example, the porosity of the third wrapper 353 may be 24000 CU, but is not limited thereto. Also, the thickness of the third wrapper 353 may be within a range of 60 μm to 70 μm, and may preferably be 68 μm. In addition, the basis weight of the third wrapper 353 may be within a range of 20 g/m² to 25 g/m², and may preferably be 21 g/m².

The fourth wrapper 354 may be made of a PLA composite. Here, the PLA composite refers to a three-layered paper including a paper layer, a PLA layer, and a paper layer. For example, the thickness of the fourth wrapper 354 may be within a range of 100 μm to 120 μm, and may preferably be 110 μm. Also, the basis weight of the fourth wrapper 354 may be within a range of 80 g/m² to 100 g/m², and may preferably be 88 g/m².

The fifth wrapper 355 may include a sterile paper (MFW). Here, the sterile paper (MFW) refers to a paper specially manufactured to have improved tensile strength, water resistance, and smoothness compared to a regular paper. For example, the basis weight of the fifth wrapper 355 may be within a range of 57 g/m² to 63 g/m², and may preferably be 60 g/m². Also, the thickness of the fifth wrapper 355 may be within a range of 64 μm to 70 μm, and may preferably be 67 μm.

The fifth wrapper 355 may have a certain material added therein. Herein, silicon may be used as an example of the certain material, but is not limited thereto. For example, silicon has characteristics such as heat resistance with little change with temperature, oxidation resistance that does not oxidize, resistance to various drugs, water repellency, electrical insulation, or the like. However, even when silicon is not used, any material having the above-described characteristics may be applied (or coated) to the fifth wrapper 355 without limitation.

The front-end plug 33 may include cellulose acetate. For example, the front-end plug 33 may be manufactured by adding a plasticizer (e.g., triacetin) to cellulose acetate tow. The mono denier of a filament configuring the cellulose acetate tow may be within a range of 1.0 to 10.0, and may preferably be within a range of 4.0 to 6.0. More preferably, the mono denier of the filament of the front-end plug 33 may be 5.0. Also, the cross section of the filament of the front-end plug 33 may have a Y shape. The total denier of the front-end plug 33 may be within a range of 20000 to 30000, and may preferably be within a range of 25000 to 30000. More preferably, the total denier of the front-end plug 33 may be 28000.

Also, according to necessity, the front-end plug 33 may include at least one channel, and the cross-sectional shape of the channel may be variously made.

The tobacco rod 31 may correspond to the tobacco rod 21 described above with reference to FIG. 4. Accordingly, a detailed description of the tobacco rod 31 is omitted below.

The first segment 321 may include cellulose acetate. For example, the first segment 321 may include a tube-type structure including a hollow inside. The first segment 321 may be manufactured by adding a plasticizer (e.g., triacetin) to cellulose acetate tow. For example, the mono denier and total denier of the first segment 321 may be equal to the mono denier and total denier of the front-end plug 33.

The second segment 322 may include cellulose acetate. The mono denier of a filament configuring the second segment 322 may be within a range of 1.0 to 10.0, and may preferably be within a range of 8.0 to 10.0. More preferably, the mono denier of the filament of the second segment 322 may be 9.0. Also, the cross section of the filament of the second segment 322 may have a Y shape. The total denier of the second segment 322 may be within a range of 20000 to 30000, and may preferably be 25000.

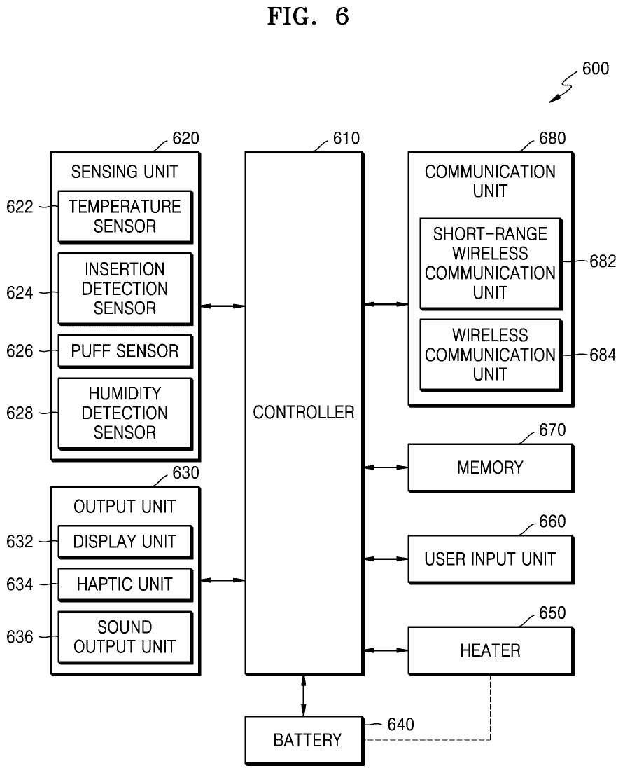

FIG. 6 is a block diagram of an aerosol generating device according to another embodiment.

An aerosol generating device 600 may include a controller 610, a sensing unit 620, an output unit 630, a battery 640, a heater 650, a user input unit 660, a memory 670, and a communication unit 680. However, the internal structure of the aerosol generating device 600 is not limited to those illustrated in FIG. 6. That is, according to the design of the aerosol generating device 600, it will be understood by one of ordinary skill in the art that some of the components shown in FIG. 6 may be omitted or new components may be added.

The sensing unit 620 may sense a state of the aerosol generating device 600 or a state around the aerosol generating device 600, and transmit sensed information to the controller 610. Based on the sensed information, the controller 610 may control the aerosol generating device 600 to perform various functions, such as controlling an operation of the heater 650, limiting smoking, determining whether an aerosol generating article (e.g., a cigarette, a cartridge, or the like) is inserted, displaying a notification, or the like.

The sensing unit 620 may include at least one of a temperature sensor 622, an insertion detection sensor 624, a puff sensor 626, and a humidity detection sensor 628, but is not limited thereto.

The temperature sensor 622 may sense a temperature at which the heater 650 (or an aerosol generating material) is heated. The aerosol generating device 600 may include a separate temperature sensor that senses the temperature of the heater 650 or the heater 650 may serve as a temperature sensor. Alternatively, the temperature sensor 622 may also be arranged around the battery 640 to monitor the temperature of the battery 640.

The temperature sensor 622 according to an embodiment may measure a temperature at which the heater 650 (or an aerosol generating material) is heated and provide the measured temperature to the controller 610. The controller 610 may calculate a time (or a temperature rise time) for the measured temperature to reach a temperature at which the aerosol generating material evaporates by using the temperature sensor 622, and may compare the calculated temperature rise time with a preset threshold value to determine a humidity state of the cigarette 2 (FIG. 2). The controller 610 may control power supplied to the heater 650 in response to the determined humidity state of the cigarette.

The insertion detection sensor 624 may sense insertion and/or removal of an aerosol generating article. For example, the insertion detection sensor 624 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 626 may sense a user's puff on the basis of various physical changes in an airflow passage or an airflow channel. For example, the puff sensor 626 may sense a user's puff on the basis of any one of a temperature change, a flow change, a voltage change, and a pressure change.

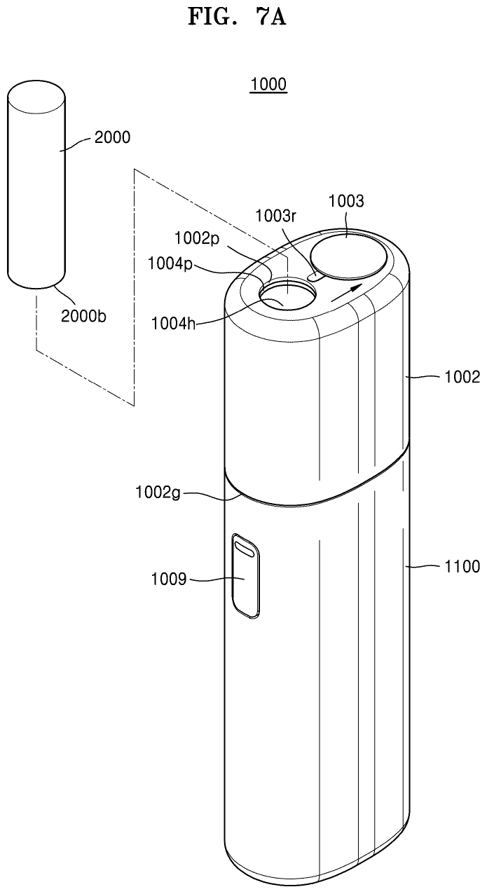

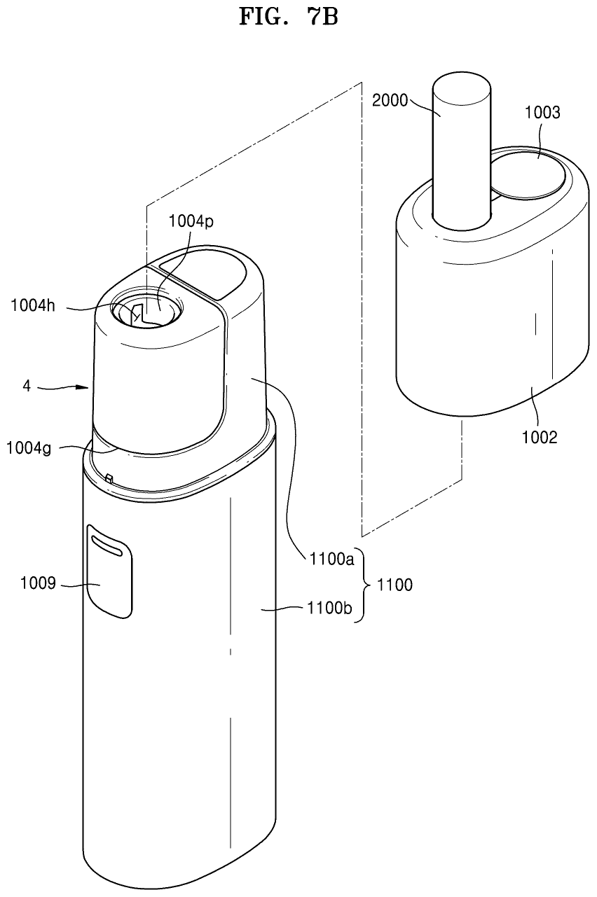

The humidity detection sensor 628 according to an embodiment may directly measure the amount of moisture contained in the cigarette 2 (FIG. 2) and provide measured humidity information to the controller 610. For example, the humidity detection sensor 628 may be arranged within an accommodating passage 1004h (FIG. 7A) of the aerosol generating device 600.

The humidity detection sensor 628 according to another embodiment may measure the amount of moisture condensed around the cigarette 2 (FIG. 2) after heating the cigarette. An over-wet cigarette may evaporate more moisture when heated than a regular cigarette. Accordingly, condensation may be more likely to occur when heating an over-wet cigarette than when heating a regular cigarette. For example, the humidity detection sensor 628 may be arranged around an external hole 1002p (FIG. 7A) or at a door 1003 (FIG. 7A), which overlaps the accommodating passage 1004h (FIG. 7A) of the aerosol generating device 600 in a thickness direction.

The humidity detection sensor 628 may be any one of an electrical resistance sensor, a capacitance sensor, and an optical sensor. However, this is only an example, and the humidity detection sensor 628 is not limited thereto.

The sensing unit 620 may further include at least one of a magnetic sensor, an acceleration sensor, a gyroscope sensor, a location sensor (e.g., a global positioning system (GPS)), a proximity sensor, and a red-green-blue (RGB) sensor, in addition to the sensors 622 to 628 described above. Because a function of each of sensors may be intuitively inferred by one of ordinary skill in the art from the name of the sensor, a detailed description thereof may be omitted.

The output unit 630 may output and provide information about a state of the aerosol generating device 600 to a user. The output unit 630 may include at least one of a display unit 632, a haptic unit 634, and a sound output unit 636, but is not limited thereto. When the display unit 632 and a touch pad form a layered structure to form a touch screen, the display unit 632 may also be used as an input device in addition to an output device.

The display unit 632 may visually provide information about the aerosol generating device 600 to the user. For example, information about the aerosol generating device 600 may mean various pieces of information, such as charging/discharging states of the battery 640 of the aerosol generating device 600, a preheating state of the heater 650, an insertion/removal state of an aerosol generating article, or a state in which the use of the aerosol generating device 600 is restricted (e.g., sensing of an abnormal object), or the like, and the display unit 632 may output the information to the outside. The display unit 632 may be, for example, a liquid crystal display (LCD) panel, an organic light-emitting diode (OLED) display panel, or the like. Also, the display unit 632 may be in the form of an LED light-emitting device.

The haptic unit 634 may tactilely provide information about the aerosol generating device 600 to the user by converting an electrical signal into a mechanical stimulus or an electrical stimulus. For example, the haptic unit 634 may include a motor, a piezoelectric element, or an electrical stimulation device.

The sound output unit 636 may audibly provide information about the aerosol generating device 600 to the user. For example, the sound output unit 636 may convert an electrical signal into a sound signal and output the same to the outside.

The battery 640 may supply power used to operate the aerosol generating device 600. The battery 640 may supply power so that the heater 650 may be heated. Also, the battery 640 may supply power required for operations of other components (e.g., the sensing unit 620, the output unit 630, the user input unit 660, the memory 670, and the communication unit 680) in the aerosol generating device 600. The battery 640 may be a rechargeable battery or a disposable battery. For example, the battery 640 may be a lithium polymer (LiPoly) battery, but is not limited thereto.

The heater 650 may receive power from the battery 640 to heat an aerosol generating material. Although not illustrated in FIG. 6, the aerosol generating device 600 may further include a power conversion circuit (e.g., a DC/DC converter) that converts power of the battery 640 and supplies the same to the heater 650. In addition, when the aerosol generating device 600 generates aerosols in an induction heating method, the aerosol generating device 600 may further include a DC/AC converter that converts DC power of the battery 640 into AC power.

The controller 610, the sensing unit 620, the output unit 630, the user input unit 660, the memory 670, and the communication unit 680 may each receive power from the battery 640 to perform a function. Although not illustrated in FIG. 6, the aerosol generating device 600 may further include a power conversion circuit that converts power of the battery 640 to supply the power to respective components, for example a low dropout (LDO) circuit or a voltage regulator circuit.

In an embodiment, the heater 650 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 650 may be implemented by a metal wire, a metal plate on which an electrically conductive track is arranged, a ceramic heating element, or the like, but is not limited thereto.

In another embodiment, the heater 650 may be a heater of an induction heating type. For example, the heater 650 may include a susceptor that heats an aerosol generating material by generating heat through a magnetic field applied by a coil.

In an embodiment, the heater 650 may include a plurality of heaters. For example, the heater 650 may include a first heater configured to heat a cigarette and a second heater configured to heat a liquid.

The user input unit 660 may receive information input from the user or may output information to the user. For example, the user input unit 660 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. Also, although not illustrated in FIG. 6, the aerosol generating device 600 may further include a connection interface, such as a universal serial bus (USB) interface, and may be connected to other external devices through the connection interface, such as the USB interface, to transmit and receive information, or to charge the battery 640.

The memory 670 is a hardware component that stores various types of data (e.g., temperature profiles) processed in the aerosol generating device 600, and may store data processed and data to be processed by the controller 610. The memory 670 may include at least one type of storage medium from among a flash memory type, a hard disk type, a multimedia card micro type memory, a card-type memory (for example, SD or XD memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 670 may store an operation time of the aerosol generating device 600, the maximum number of puffs, the current number of puffs, at least one temperature profile, data on a user's smoking pattern, etc.

The communication unit 680 may include at least one component for communication with another electronic device. For example, the communication unit 680 may include a short-range wireless communication unit 682 and a wireless communication unit 684.

The short-range wireless communication unit 682 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra wideband (UWB) communication unit, an Ant+ communication unit, or the like, but is not limited thereto.

The wireless communication unit 684 may include a cellular network communication unit, an Internet communication unit, a computer network (e.g., local area network (LAN) or wide area network (WAN)) communication unit, or the like, but is not limited thereto. The wireless communication unit 684 may also identify and authenticate the aerosol generating device 600 within a communication network by using subscriber information (e.g., International Mobile Subscriber Identifier (IMSI)).

The controller 610 may control the overall operation of the aerosol generating device 600. In an embodiment, the controller 610 may include at least one processor. The processor may be implemented as an array of a plurality of logic gates, or may be implemented as a combination of a general-purpose microprocessor and a memory in which a program executable by the microprocessor is stored. It will be understood by one of ordinary skill in the art that the processor may be implemented in other forms of hardware.

The controller 610 may control the temperature of the heater 650 by controlling supply of the battery 640 to the heater 650. For example, the controller 610 may control power supply by controlling switching of a switching element between the battery 640 and the heater 650. In another embodiment, a direct heating circuit may also control power supply to the heater 650 in response to a control command of the controller 610.

The controller 610 may analyze a result sensed by the sensing unit 620 and control subsequent processes to be performed. For example, the controller 610 may control power supplied to the heater 650 to start or end an operation of the heater 650 on the basis of a result sensed by the sensing unit 620. In another embodiment, the controller 610 may control, based on a result sensed by the sensing unit 620, an amount of power supplied to the heater 650 and the time the power is supplied, such that the heater 650 may be heated to a certain temperature or maintained at an appropriate temperature.

The controller 610 may control the output unit 630 on the basis of a result sensed by the sensing unit 620. For example, when the number of puffs counted through the puff sensor 626 reaches a preset number, the controller 610 may notify the user that the aerosol generating device 600 will soon be terminated through at least one of the display unit 632, the haptic unit 634, and the sound output unit 636.

The controller 610 may determine the humidity state of a cigarette by using the temperature sensor 622. The controller 610 may operate the heater 650 with a temperature profile corresponding to the determined humidity state of the cigarette.

Hereinafter, with reference to FIGS. 7A through 10, an aerosol generating device that distinguishes between a regular cigarette and an over-wet cigarette on the basis of a temperature rise time of the cigarette 2 (FIG. 2) and applies a compensation profile in the case of an over-wet cigarette, and an operating method of the aerosol generating device are described in detail.

FIG. 7A is a perspective view showing the exterior of an aerosol generating device according to an embodiment of the present disclosure. FIG. 7B is a perspective view showing an operating state in which some components are separated from the aerosol generating device according to the embodiment shown in FIG. 7A.

Referring to FIG. 7A, an aerosol generating device 1000 may include a case 1100 and a cover 1002. The cover 1002 is coupled to a side end portion of the case 1100, so that the case 1100 and the cover 1002 together form the exterior of the aerosol generating device 1000.

The case 1100 forms part of the exterior of the aerosol generating device 1000 and performs a function of accommodating and protecting various components.

The cover 1002 and the case 1100 may be made of a plastic material that does not transmit heat well or a metal material with a heat-insulating material coated on the surface thereof. The cover 1002 and the case 1100 may be manufactured, for example, by an injection molding method, a three-dimensional (3D) printing method, or a method of assembling small parts manufactured by injection molding.

A maintenance device (not shown) may be installed between the cover 1002 and the case 1100 to maintain the coupled state of the cover 1002 and the case 1100. The maintenance device may include, for example, a protrusion and a groove. The coupled state of the cover 1002 and the case 1100 may be maintained by maintaining a state in which the protrusion is inserted into the groove, and a structure may also be used in which the protrusion is moved by an operation button that may be pressed by the user to be separated from the groove.

Also, the maintenance device may include, for example, a magnet and a metal member that adheres to the magnet. When a magnet is used in the maintenance device, the magnet may be installed in any one of the case 1100 and the cover 1002, and the metal member that adheres to the magnet may be installed in the other one of the case 1100 and the cover 1002, or the magnet may be installed in both the case 1100 and the cover 1002.

An external hole 1002p into which a cigarette 2000 may be inserted is formed on an upper surface of the cover 1002 coupled to the case 1100. Also, a rail 1003r is formed on the upper surface of the cover 1002 at a position adjacent to the external hole 1002p. A door 1003 that may slide and move along the upper surface of the cover 1002 is installed on the rail 1003r. The door 1003 may linearly slide and move along the rail 1003r.

The door 1003 moves along the rail 1003r in a direction of an arrow of FIG. 7A, thereby exposing the external hole 1002p and an insertion hole 1004p to the outside so that the cigarette 2000 may be inserted into the case 1100 by passing through the cover 1002. The external hole 1002p of the cover 1002 exposes the insertion hole 1004p of the accommodating passage 1004h capable of accommodating the cigarette 2000.

When the external hole 1002p is exposed to the outside by the door 1003, the user may insert an end portion 2000b of the cigarette 2000 into the external hole 1002p and the insertion hole 1004p to mount the cigarette 2000 in the accommodating passage 1004h formed inside the cover 1002.

The rail 1003r has a concave groove shape, but the embodiment is not limited by the shape of the rail 1003r. For example, the rail 1003r may have a convex shape or may extend in a curved shape rather than a straight line shape.

A button 1009 is installed in the case 1100. An operation of the aerosol generating device 1000 may be controlled as the button 1009 is operated.

In a state in which the cover 1002 is coupled to the case 1100, an external air inflow gap 1002g is formed at an area where the cover 1002 and the case 1100 are coupled to allow air to flow into the cover 1002.

Referring to FIG. 7B, in a state in which the cigarette 2000 is inserted into the aerosol generating device 1000, the user may inhale aerosols by biting the cigarette 2000 with his/her mouth.

The case 1100 may include an upper case 1100a into which the cigarette 2000 is inserted and the cigarette 2000 is heated, and a lower case 1100b that supports and protects various components installed therein. Hereinafter, the description of the case 1100 includes both the upper case 1100a and the lower case 1100b.

The cover 1002 may be coupled to the case 1100 to cover a cigarette support portion 4 coupled to the case 1100. Also, according to necessity, the cover 1002 may be separated from the case 1100.

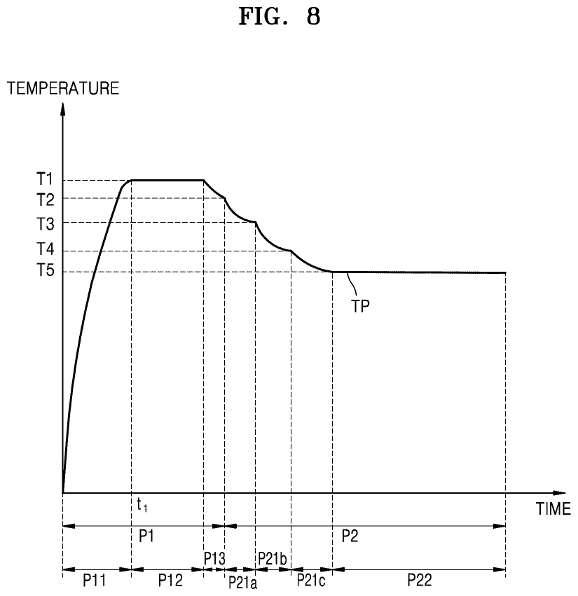

FIG. 8 shows an example to describe a basic temperature profile of an aerosol generating device.

Referring to FIGS. 6 and 8, the controller 610 of the aerosol generating device 600 may calculate a temperature rise time t₁ of the cigarette 2000 (FIG. 7A) by using the temperature sensor 622 and compare the calculated temperature rise time t₁ of the cigarette 2000 with a preset threshold value to determine the humidity state of the cigarette 2000. When the temperature rise time t1 is less than the threshold value, the controller 610 may supply power to the heater 650 according to a basic temperature profile TP.

At this time, the preset threshold value may be determined experimentally and statistically as a time for an over-wet cigarette to reach a first target temperature T1. When the heater 650 operates according to the basic temperature profile TP even when a time to reach the first target temperature T1 is at the threshold value or more, the user may feel hot due to moisture included inside the cigarette 2000.

As shown in FIG. 8, the basic temperature profile TP may include a first preheating section P1 and a first smoking section P2, and the first preheating section P1 and the first smoking section P2 may be further divided into sub-sections.

The first preheating section P1 may include a first preheating rising section P11 (or the temperature rise time t₁) to raise to the first target temperature T1, a first preheating maintaining section P12 to maintain the first target temperature T1, and a first preheating lowering section P13 to lower to a second target temperature T2.

The first smoking section P2 may include a first-1 smoking lowering section P21a to lower to a third target temperature T3, a first-2 smoking lowering section P21b to lower to a fourth target temperature T4, a first-3 smoking lowering section P21c to lower to a fifth target temperature T5, and a first smoking maintaining section P22 to maintain the fifth target temperature T5. Here, the case in which the first preheating section P1 includes the first preheating rising section P11, the first preheating maintaining section P12, and the first preheating lowering section P13, and the first smoking section P2 includes the first-1 smoking lowering section P21a, the first-2 smoking lowering section P21b, the first-3 smoking lowering section P21c, and the first smoking maintaining section P22 is described as an example, but the disclosure is not limited thereto, and various modifications are possible depending on the shape or type of a cigarette or heater.

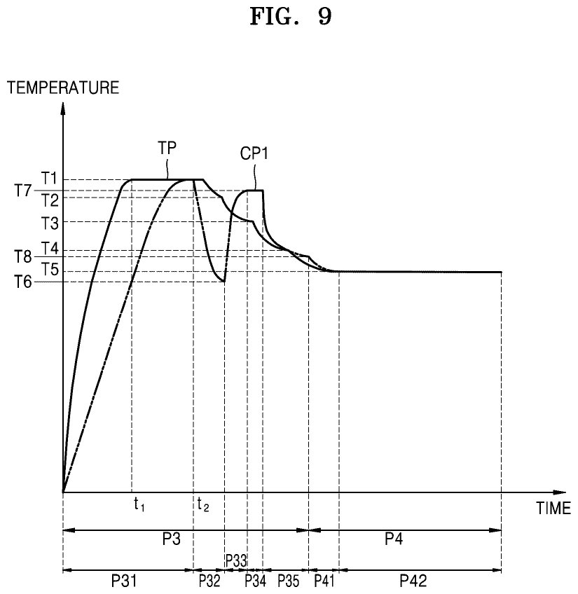

FIG. 9 shows an example to describe a first compensation profile of an aerosol generating device.

Referring to FIGS. 6, 8, and 9, the aerosol generating device 600 may operate the heater 650 by applying a first compensation profile CP1 to be described below, when it is determined that the inserted cigarette 2000 (FIG. 7A) is an over-wet cigarette.

The controller 610 according to an embodiment may calculate a temperature rise time t₂ of the cigarette 2000 by using the temperature sensor 622 and compare the calculated temperature rise time t₂ of the cigarette 2000 with a preset threshold value to determine the humidity state of the cigarette 2000. The controller 610 may supply power to the heater 650 according to the first compensation profile CP1 when the temperature rise time t2 is at the threshold value or more.

However, a method of determining the humidity state of the cigarette 2000 is not limited thereto. The controller 610 according to another embodiment may determine the humidity state of the cigarette 2000 by using the humidity detection sensor 628.

The humidity detection sensor 628 according to an embodiment may directly measure the amount of moisture contained in the cigarette 2000 and provide the measured humidity information to the controller 610. For example, the humidity detection sensor 628 may be arranged within the accommodating passage 1004h (FIG. 7A) of the aerosol generating device 600. The humidity detection sensor 628 according to another embodiment may measure the amount of moisture condensed around the cigarette 2 (FIG. 2) after heating the cigarette. An over-wet cigarette may evaporate more moisture when heated than a regular cigarette. Accordingly, condensation may be more likely to occur when heating an over-wet cigarette than when heating a regular cigarette. For example, the humidity detection sensor 628 may be arranged around the external hole 1002p (FIG. 7A) or at the door 1003 (FIG. 7A), which overlaps the accommodating passage 1004h (FIG. 7A) of the aerosol generating device 600 in a thickness direction.

The humidity detection sensor 628 may be any one of an electrical resistance sensor, a capacitance sensor, and an optical sensor. However, this is only an example, and the humidity detection sensor 628 is not limited thereto.

As shown in FIG. 9, the first compensation profile CP1 may include a second preheating section P3 and a second smoking section P4, and the second preheating section P3 and the second smoking section P4 may be further divided into sub-sections.

The second preheating section P3 may include a second preheating rising section P31 (or the temperature rise time t₂) to raise to the first target temperature T1, a second preheating lowering section P32 to lower to a sixth target temperature T6, a second preheating re-rising section P33 to raise to a seventh target temperature T7, a second preheating maintaining section P34 to maintain the seventh target temperature T7, and a second preheating re-lowering section P35 to lower to an eighth target temperature T8. The second smoking section P4 may include a second smoking lowering section P41 to lower to the fifth target temperature T5 and a second smoking maintaining section P42 to maintain the fifth target temperature T5. For example, the fifth target temperature T5 may be about 200 °C.

Here, a case in which the second preheating section P3 includes the second preheating rising section P31, the second preheating lowering section P32, the second preheating re-rising section P33, the second preheating maintaining section P34, and the second preheating re-lowering section P35, and the second smoking section P4 includes the second smoking lowering section P41 and the second smoking maintaining section P42 is described as an example, but the disclosure is not limited thereto, and various modifications are possible depending on the shape or type of a cigarette or heater.

Referring to FIGS. 8 and 9, the second preheating section P3 of the first compensation profile CP1 may be longer than the first preheating section P1 of the basic temperature profile TP.

In detail, the second preheating rising section P31 of the first compensation profile CP1 may be longer than the first preheating rising section P11 of the basic temperature profile TP. For example, the t₂ time point of the first compensation profile CP1 and the t₁ time point of the basic temperature profile TP may have a difference of about 3 to 4 seconds. That is, because an over-wet cigarette contains more moisture than a regular cigarette, the rate of raising the temperature of the cigarette may slow down as the speed of evaporating the moisture therein that needs to be heated decreases.

Unlike that the basic temperature profile TP includes the first preheating maintaining section P12 after the first preheating rising section P11, the first compensation profile CP1 may include the second preheating lowering section P32 after the second preheating rising section P31.

The controller 610 according to an embodiment may turn off the heater 650 during the second preheating lowering section P32. The controller 610 may supply power to the temperature sensor 622 for temperature sensing even during the second preheating lowering section P32. The controller 610 may maintain the turn-off state of the heater 650 until the temperature of the cigarette 2000 (or the heater 650) reaches the sixth target temperature T6 through the temperature sensor 622.

When the heater 650 is turned off, the temperature of the cigarette 2000 (or the heater 650) may decrease from the first target temperature T1 to the sixth target temperature T6. For example, the first target temperature T1 may be about 260 °C, and the sixth target temperature T6 may be 190 °C. That is, the temperature difference between a starting point and an end point of the second preheating lowering section P32 may be about 70 °C.

As such, as the temperature of an over-wet temperature decreases significantly during the second preheating lowering section P32, moisture (or saturated moisture) within the over-wet cigarette may be condensed.

The first compensation profile CP1 may include the second preheating re-rising section P33 directly after the second preheating lowering section P32.

The controller 610 according to an embodiment may turn on the heater 650 when the temperature of the cigarette 2000 (or the heater 650) reaches the sixth target temperature T6 through the temperature sensor 622. The controller 610 may operate the heater 650 until the temperature of the cigarette 2000 (or the heater 650) reaches the seventh target temperature T7. The condensed moisture within the over-wet cigarette may evaporate to the outside.

According to an embodiment, the seventh target temperature T7 may be lower than the first target temperature T1. That is, the difference between the first target temperature T1 and the sixth target temperature T6 may be less than the difference between the sixth target temperature T6 and the seventh target temperature T7. For example, the first target temperature T1 may be about 260 °C, and the seventh target temperature T7 may be 240 °C. That is, the temperature difference between a starting point and an end point of the second preheating re-rising section P33 may be about 50 °C.

This is because the moisture within the over-wet cigarette may be more effectively removed when the moisture within the over-wet cigarette is condensed and then re-heated by generating a large temperature difference, as compared with the case in which the over-wet cigarette is continuously heated at a high temperature. Accordingly, it may be expected that the risk of burns is reduced by producing mainstream smoke generated from the over-wet cigarette at a lower temperature.

However, the setting of the seventh target temperature T7 is not limited thereto. For example, although not illustrated in FIG. 9, the seventh target temperature T7 may also be set to be equal to or greater than the first target temperature T1. As the seventh target temperature T7 increases, the initial vapor amount generated from the cigarette 2000 may increase. Accordingly, the seventh target temperature T7 may be experimentally and statistically set by considering the amount of vapor and the temperature of the mainstream smoke, which have a trade-off relationship.

The first compensation profile CP1 may include the second preheating maintaining section P34 after the second preheating re-rising section P33. The second preheating maintaining section P34 may be shorter than the first preheating maintaining section P12 of the basic temperature profile TP. This is because the temperature of the mainstream smoke generated from the over-wet cigarette is generated at a lower state (that is, the seventh target temperature T7 that is lower than the first target temperature T1).

However, the maintaining time of the second preheating maintaining section P34 is not limited thereto. For example, although not illustrated in FIG. 9, the second preheating maintaining section P34 may be equal to or longer than the first preheating maintaining section P12 of the basic temperature profile TP. As the second preheating maintaining section P34 becomes longer, more moisture contained in the over-wet cigarette may be removed, thereby alleviating the initial feeling of heat. Accordingly, the second preheating maintaining section P34 may be experimentally and statistically set by considering the reduction in initial feeling of heat and the reduction in preheating time, which have a trade-off relationship.

The first compensation profile CP1 may include the second preheating re-lowering section P35 after the second preheating maintaining section P34. A change in temperature within the second preheating re-lowering section P35 of the first compensation profile CP1 may be greater than a change in temperature within the first preheating lowering section P13 of the basic temperature profile TP. For example, the first preheating lowering section P13 may be changed from the first target temperature T1 to the second target temperature T2, but the second preheating re-lowering section P35 may be changed from the seventh target temperature T7 to the eighth target temperature T8. Because a regular cigarette is unlikely to make the user feel hot due to the moisture contained therein, smoking may be possible from the second target temperature T2 that is higher than the fifth target temperature T5. However, because an over-wet cigarette contains more moisture therein than a regular cigarette, the initial feeling of heat may be alleviated by setting a greater temperature change within the second preheating re-lowering section P35.

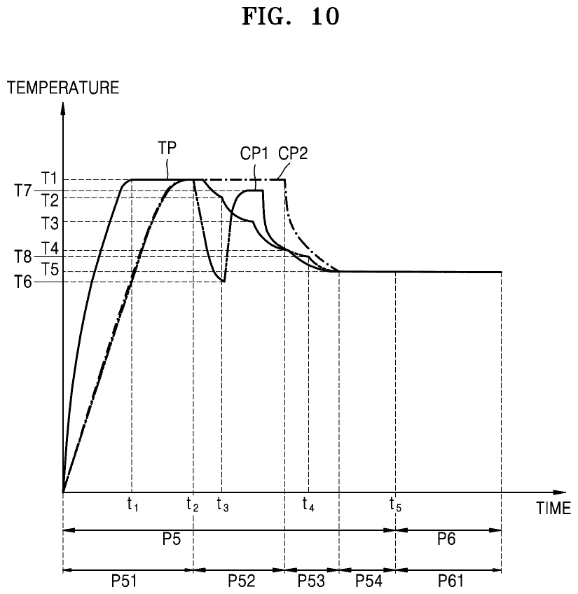

FIG. 10 shows an example to describe a second compensation profile for an over-wet cigarette, according to another embodiment to describe an effect of the first compensation profile shown in FIG. 9.

Referring to FIGS. 6, 8, 9, and 10, the aerosol generating device 600 may operate the heater 650 by applying a second compensation profile CP2 to be described below, when it is determined that the inserted cigarette 2000 (FIG. 7A) is an over-wet cigarette.

The controller 610 according to an embodiment may calculate a temperature rise time t₂ of the cigarette 2000 by using the temperature sensor 622 and compare the calculated temperature rise time t₂ of the cigarette 2000 with a preset threshold value to determine the humidity state of the cigarette 2000. The controller 610 may supply power to the heater 650 according to the second compensation profile CP2 when the temperature rise time t₂ is at the threshold value or more.

However, a method of determining the humidity state of the cigarette 2000 is not limited thereto. The controller 610 according to another embodiment may determine the humidity state of the cigarette 2000 by using the humidity detection sensor 628.

As shown in FIG. 10, the second compensation profile CP2 may include a third preheating section P5 and a third smoking section P6, and the third preheating section P5 and the third smoking section P6 may be further divided into sub-sections.

The third preheating section P5 may include a third preheating rising section P51 (or the temperature rise time t₂) to raise to the first target temperature T1, a third-1 preheating maintaining section P52 to maintain the first target temperature T1, a third preheating lowering section P53 to lower to the fifth target temperature T5, and a third-2 preheating maintaining section P54 to maintain the fifth target temperature T5. The third smoking section P6 may include a third smoking maintaining section P61 to maintain the fifth target temperature T5. Here, the case in which the third preheating section P5 includes the third preheating rising section P51, the third-1 preheating maintaining section P52, the third preheating lowering section P53, and the third-2 preheating maintaining section P54, and the third smoking section P6 includes the third smoking maintaining section P61 is described as an example, but the disclosure is not limited thereto, and various modifications are possible depending on the shape or type of a cigarette or heater.

Referring to FIGS. 8 and 10, the third preheating section P5 of the second compensation profile CP2 may be longer than the first preheating section P1 of the basic temperature profile TP. In other words, smoking may be possible from a t₅ time point when an over-wet cigarette is heated by the second compensation profile CP2. On the contrary, smoking may be possible from a t₃ time point that is earlier than the t₅ time point when a regular cigarette is heated by the basic temperature profile TP.

In detail, the third preheating rising section P51 of the second compensation profile CP2 may be longer than the first preheating rising section P11 of the basic temperature profile TP. For example, the t₂ time point of the second compensation profile CP2 and the t₁ time point of the basic temperature profile TP may have a difference of about 3 to 4 seconds. That is, because an over-wet cigarette contains more moisture than a regular cigarette, the rate of raising the temperature of the cigarette may slow down as the speed of evaporating the moisture therein that needs to be heated decreases.

The third-1 preheating maintaining section P52 of the second compensation profile CP2 may be longer than the first preheating maintaining section P12 of the basic temperature profile TP. Accordingly, the initial feeling of heat may be alleviated as more moisture contained in the cigarette 2000 is evaporated.

Also, a change in temperature within the third preheating lowering section P53 of the second compensation profile CP2 may be greater than a change in temperature within the first preheating lowering section P13 of the basic temperature profile TP. For example, the first preheating lowering section P13 may be changed from the first target temperature T1 to the second target temperature T2, but the third preheating lowering section P53 may be changed from the first target temperature T1 to the fifth target temperature T5. Because a regular cigarette is unlikely to make the user feel hot due to the moisture contained therein, smoking may be possible from the second target temperature T2 that is higher than the fifth target temperature T5. However, because an over-wet cigarette contains more moisture therein than a regular cigarette, the initial feeling of heat may be alleviated by setting a greater temperature change within the third preheating lowering section P53.

Also, the third preheating section P5 of the second compensation profile CP2 may additionally include the third-2 preheating maintaining section P54 to maintain the fifth target temperature T5 to alleviate the initial feeling of heat.

Referring to FIGS. 9 and 10, the second preheating section P3 of the first compensation profile CP1 may be shorter than the third preheating section P5 of the second compensation profile CP2.

In other words, smoking may be possible from the t₅ time point when an over-wet cigarette is heated by the second compensation profile CP2. On the contrary, smoking may be possible from the t₄ time point that is earlier than the t₅ time point when an over-wet cigarette is heated by the first compensation profile CP1 according to an embodiment of the present disclosure.

This is because the first compensation profile CP1 includes the second preheating lowering section P32 for condensing moisture within an over-wet cigarette and the second preheating re-rising section P33 for vaporizing the condensed moisture. That is, the moisture within the over-wet cigarette may be more quickly removed when the moisture within the over-wet cigarette is condensed and then re-heated by generating a large temperature difference, as compared with the case in which the over-wet cigarette is continuously heated at a high temperature.

Also, an amount of heat applied to a cigarette by the first compensation profile CP1 may be less than an amount of heat applied to the cigarette by the second compensation profile CP2. In detail, the horizontal axis of the graph illustrated in FIG. 10 corresponds to a time domain, and the vertical axis corresponds to a temperature domain, and thus the area of the graph may correspond to an amount of heat applied to a cigarette. The area of the graph corresponding to the first compensation profile CP1 may be less than the area of the graph corresponding to the second compensation profile CP2.

This is because the second compensation profile CP2 vaporizes moisture within an over-wet cigarette by maintaining the first target temperature T1 at a high temperature in the third-1 preheating maintaining section P52, whereas the first compensation profile CP1 condenses moisture within the over-wet cigarette by lowering the temperature from the first target temperature T1 to the sixth target temperature T6 in the second preheating lowering section P32 and vaporizes the condensed moisture by raising the temperature to the seventh target temperature T7 that is lower than the first target temperature T1 in the second preheating re-rising section P33.

When an over-wet cigarette is heated by the first compensation profile CP1, it may be expected that he risk of burns to the user may be prevented by reducing the initial feeling of heat compared to when heating the over-wet cigarette by the second compensation profile CP2.

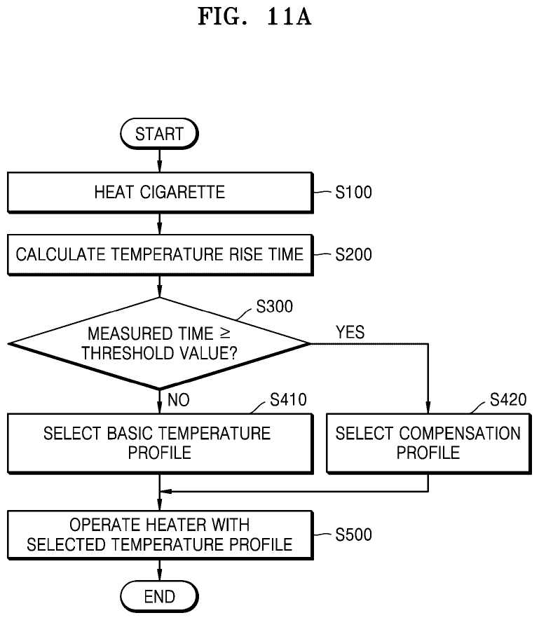

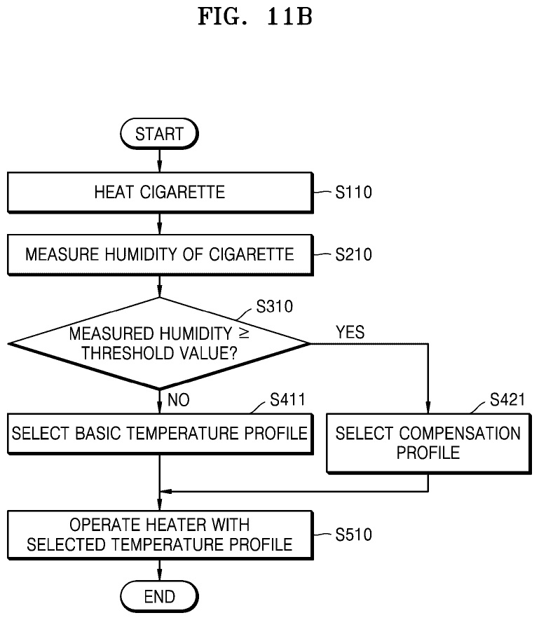

FIG. 11A is a flowchart illustrating an operating method of an aerosol generating device according to an embodiment, in consideration of the humidity state of a cigarette.

Referring to FIGS. 6 through 11A, an operating method of an aerosol generating device may include operation S100 of heating the cigarette 2000 by the heater 650, operation S200 of calculating a temperature rise time of the cigarette 2000 by measuring the temperature of the heater 650 by the temperature sensor 622, operation S300 of determining the humidity state of the cigarette 2000 by comparing the calculated temperature rise time of the cigarette 2000 with a preset threshold value, operation S400 of selecting a temperature profile corresponding to the determined humidity state of the cigarette 2000, and operation S500 of operating the heater 650 with the selected temperature profile.

In detail, in operation S100 of heating the cigarette 2000 by the heater 650, an over-wet cigarette contains more moisture than a regular cigarette, and thus a rate of raising the temperature of the cigarette may slow down as the speed of evaporating the moisture therein that needs to be heated decreases.

In operation S200 of calculating the temperature rise time of the cigarette 2000 by measuring the temperature of the heater 650 by the temperature sensor 622, the controller 610 may determine the time for the temperature of the heater 650 to reach the preset first target temperature T1 as the temperature rise time of the cigarette 2000.

In operation S300 of determining the humidity state of the cigarette 2000 by comparing the calculated temperature rise time of the cigarette 2000 with the preset threshold value, the controller 610 may determine the cigarette 2000 as a regular cigarette when the temperature rise time is less than the threshold value, and may determine the cigarette 2000 as an over-wet cigarette when the temperature rise time is at the threshold value or more.

At this time, the preset threshold value may be determined experimentally and statistically as a time for an over-wet cigarette to reach a first target temperature T1. When the heater 650 operates according to the basic temperature profile TP even when a time to reach the first target temperature T1 is at the threshold value or more, the user may feel hot due to moisture included inside the cigarette 2000.

In operation S400 of selecting the temperature profile corresponding to the determined humidity state of the cigarette 2000, the controller 610 may select the basic temperature profile TP when the temperature rise time is less than the threshold value, and may select the first compensation profile CP1 when the temperature rise time is at the threshold value or more.

In operation S500 of operating the heater 650 with the selected temperature profile, the controller 610 may supply power to the heater 650 according to the basic temperature profile TP when the temperature rise time is less than the threshold value, and may supply power to the heater 650 according to the first compensation profile CP1 when the temperature rise time is at the threshold value or more.

The basic temperature profile TP may include the first preheating section P1 and the first smoking section P2, and the first preheating section P1 and the first smoking section P2 may be further divided into sub-sections. The first compensation profile CP1 may include the second preheating section P3 and the second smoking section P4, and the second preheating section P3 and the second smoking section P4 may be further divided into sub-sections.

Unlike that the basic temperature profile TP includes the first preheating maintaining section P12 after the first preheating rising section P11, the first compensation profile CP1 may include the second preheating lowering section P32 after the second preheating rising section P31.

The controller 610 according to an embodiment may turn off the heater 650 during the second preheating lowering section P32. The controller 610 may supply power to the temperature sensor 622 for temperature sensing even during the second preheating lowering section P32. The controller 610 may maintain the turn-off state of the heater 650 until the temperature of the cigarette 2000 (or the heater 650) reaches the sixth target temperature T6 through the temperature sensor 622.

When the heater 650 is turned off, the temperature of the cigarette 2000 (or the heater 650) may decrease from the first target temperature T1 to the sixth target temperature T6. For example, the first target temperature T1 may be about 260 °C, and the sixth target temperature T6 may be 190 °C. That is, the temperature difference between a starting point and an end point of the second preheating lowering section P32 may be about 70 °C.

As such, as the temperature of an over-wet temperature decreases significantly during the second preheating lowering section P32, moisture (or saturated moisture) within the over-wet cigarette may be condensed.

The first compensation profile CP1 may include the second preheating re-rising section P33 directly after the second preheating lowering section P32.

The controller 610 according to an embodiment may turn on the heater 650 when the temperature of the cigarette 2000 (or the heater 650) reaches the sixth target temperature T6 through the temperature sensor 622. The controller 610 may operate the heater 650 until the temperature of the cigarette 2000 (or the heater 650) reaches the seventh target temperature T7. The condensed moisture within the over-wet cigarette may evaporate to the outside.

According to an embodiment, the seventh target temperature T7 may be lower than the first target temperature T1. That is, the difference between the first target temperature T1 and the sixth target temperature T6 may be less than the difference between the sixth target temperature T6 and the seventh target temperature T7. For example, the first target temperature T1 may be about 260 °C, and the seventh target temperature T7 may be 240 °C. That is, the temperature difference between a starting point and an end point of the second preheating re-rising section P33 may be about 50 °C.

This is because the moisture within the over-wet cigarette may be more effectively removed when the moisture within the over-wet cigarette is condensed and then re-heated by generating a large temperature difference, as compared with the case in which the over-wet cigarette is continuously heated at a high temperature. Accordingly, it may be expected that the risk of burns is reduced by producing mainstream smoke generated from the over-wet cigarette at a lower temperature.

However, the setting of the seventh target temperature T7 is not limited thereto. For example, although not illustrated in FIG. 9, the seventh target temperature T7 may also be set to be equal to or greater than the first target temperature T1. As the seventh target temperature T7 increases, the initial vapor amount generated from the cigarette 2000 may increase. Accordingly, the seventh target temperature T7 may be experimentally and statistically set by considering the amount of vapor and the temperature of the mainstream smoke, which have a trade-off relationship.

The first compensation profile CP1 may include the second preheating maintaining section P34 after the second preheating re-rising section P33. The second preheating maintaining section P34 may be shorter than the first preheating maintaining section P12 of the basic temperature profile TP. This is because the temperature of the mainstream smoke generated from the over-wet cigarette is generated at a lower state (that is, the seventh target temperature T7 that is lower than the first target temperature T1).

However, the maintaining time of the second preheating maintaining section P34 is not limited thereto. For example, although not illustrated in FIG. 9, the second preheating maintaining section P34 may be equal to or longer than the first preheating maintaining section P12 of the basic temperature profile TP. As the second preheating maintaining section P34 becomes longer, more moisture contained in the over-wet cigarette may be removed, thereby alleviating the initial feeling of heat. Accordingly, the second preheating maintaining section P34 may be experimentally and statistically set by considering the reduction in initial feeling of heat and the reduction in preheating time, which have a trade-off relationship.

The first compensation profile CP1 may include the second preheating re-lowering section P35 after the second preheating maintaining section P34. A change in temperature within the second preheating re-lowering section P35 of the first compensation profile CP1 may be greater than a change in temperature within the first preheating lowering section P13 of the basic temperature profile TP. For example, the first preheating lowering section P13 may be changed from the first target temperature T1 to the second target temperature T2, but the second preheating re-lowering section P35 may be changed from the seventh target temperature T7 to the eighth target temperature T8. Because a regular cigarette is unlikely to make the user feel hot due to the moisture contained therein, smoking may be possible from the second target temperature T2 that is higher than the fifth target temperature T5. However, because an over-wet cigarette contains more moisture therein than a regular cigarette, the initial feeling of heat may be alleviated by setting a greater temperature change within the second preheating re-lowering section P35.

FIG. 11B is a flowchart illustrating an operating method of an aerosol generating device according to another embodiment, in consideration of the humidity state of a cigarette.

The embodiment illustrated in FIG. 11B differs from the embodiment illustrated in FIG. 11A, in which the humidity state of a cigarette is determined by using a temperature sensor, in determining the humidity state of a cigarette by using a humidity detection sensor, but the remaining configurations are substantially the same. Hereinafter, redundant descriptions of identical components are omitted, and differences are mainly described.

Referring to FIGS. 6 through 11B, an operating method of an aerosol generating device may include operation S110 of heating the cigarette 2000 by the heater 650, operation S210 of measuring the humidity of the cigarette 2000 by using the humidity detection sensor 628, operation S310 of determining the humidity state of the cigarette 2000 by comparing the measured humidity of the cigarette 2000 with a preset threshold value, operation S410 of selecting a temperature profile corresponding to the determined humidity state of the cigarette 2000, and operation S510 of operating the heater 650 with the selected temperature profile.

In detail, in operation S210 of measuring the humidity of the cigarette 2000 by using the humidity detection sensor 628, the controller 610 may determine the humidity state of the cigarette 2000 by using the humidity detection sensor 628. The humidity detection sensor 628 according to an embodiment may directly measure the amount of moisture contained in the cigarette 2000 and provide the measured humidity information to the controller 610. For example, the humidity detection sensor 628 may be arranged within an accommodating passage 1004h (FIG. 7A) of the aerosol generating device 600. The humidity detection sensor 628 according to another embodiment may measure the amount of moisture condensed around the cigarette 2 (FIG. 2) after heating the cigarette. An over-wet cigarette may evaporate more moisture when heated than a regular cigarette. Accordingly, condensation may be more likely to occur when heating an over-wet cigarette than when heating a regular cigarette. For example, the humidity detection sensor 628 may be arranged around an external hole 1002p (FIG. 7A) or at a door 1003 (FIG. 7A), which overlaps the accommodating passage 1004h (FIG. 7A) of the aerosol generating device 600 in a thickness direction.

The humidity detection sensor 628 may be any one of an electrical resistance sensor, a capacitance sensor, and an optical sensor. However, this is only an example, and the humidity detection sensor 628 is not limited thereto.

In operation S310 of determining the humidity state of the cigarette 2000 by comparing the measured humidity of the cigarette 2000 with the preset threshold value, the controller 610 may determine the cigarette 2000 as a regular cigarette when the measured humidity of the cigarette 2000 is less than the threshold value, and may determine the cigarette 2000 as an over-wet cigarette when the measured humidity of the cigarette 2000 is at the threshold value or more. At this time, the preset threshold value may be the minimum humidity at which the user may feel hot due to moisture contained inside the cigarette 2000 when the user inhales aerosols.

In operation S410 of selecting the temperature profile corresponding to the determined humidity state of the cigarette 2000, the controller 610 may select the basic temperature profile TP when the measured humidity of the cigarette 2000 is less than the threshold value, and may select the first compensation profile CP1 when the measured humidity of the cigarette 2000 is at the threshold value or more.

In operation S510 of operating the heater 650 with the selected temperature profile, the controller 610 may supply power to the heater 650 according to the basic temperature profile TP when the measured humidity of the cigarette 2000 is less than the threshold value, and may supply power to the heater 650 according to the first compensation profile CP1 when the measured humidity of the cigarette 2000 is at the threshold value or more.

As such, the aerosol generating device 600 according to the present disclosure may select a temperature profile corresponding to a humidity state and operate the heater 650 according to the selected temperature profile, based on the humidity state of the cigarette 2000. Accordingly, the aerosol generating device 600 may alleviate the feeling of heat of mainstream smoke and ensure the amount of aerosols while reducing the preheating time.

Those of ordinary skill in the art pertaining to the present embodiments can understand that various changes in form and details can be made therein without departing from the scope of the characteristics described above. The disclosed methods should be considered in descriptive sense only and not for purposes of limitation. The scope of the present disclosure is defined by the appended claims rather than by the foregoing description, and all differences within the scope of equivalents thereof should be construed as being included in the present disclosure.

1. An aerosol generating device comprising:
a heater configured to heat a cigarette;
a temperature sensor configured to measure a temperature of the heater; and
a controller configured to calculate a temperature rise time of the cigarette by using the temperature sensor and compare the calculated temperature rise time of the cigarette with a preset threshold value to determine a humidity state of the cigarette;
wherein the controller supplies power to the heater according to a compensation profile when the temperature rise time is at the threshold value or more, the compensation profile comprising a preheating section including a temperature lowering section to condense moisture within the cigarette and a temperature re-rising section to vaporize the condensed moisture.

2. The aerosol generating device of claim 1, wherein the controller supplies power to the heater according to a basic temperature profile when the temperature rise time is less than the threshold value.

3. The aerosol generating device of claim 2, wherein the basic temperature profile comprises a first preheating section and a first smoking section,
the compensation profile comprises a second preheating section and a second smoking section,
the first preheating section comprises a first preheating rising section, a first preheating maintaining section, and a first preheating lowering section, and
the second preheating section comprises a second preheating rising section, a second preheating lowering section, a second preheating re-rising section, a second preheating maintaining section, and a second preheating re-lowering section.

4. The aerosol generating device of claim 3, wherein the first smoking section comprises a first smoking lowering section and a first smoking maintaining section, and the second smoking section comprises a second smoking lowering section and a second smoking maintaining section.

5. The aerosol generating device of claim 4, wherein a target minimum temperature of the second preheating lowering section is less than a target maintenance temperature of the first smoking maintaining section.

6. The aerosol generating device of claim 4, wherein a target maximum temperature of the second preheating re-rising section is less than a target maintenance temperature of the first preheating maintaining section.

7. The aerosol generating device of claim 4, wherein a target minimum temperature of the second preheating re-lowering section is greater than a target maintenance temperature of the first smoking maintaining section.

8. The aerosol generating device of claim 3, wherein the controller turns off the heater during the second preheating lowering section.

9. The aerosol generating device of claim 8, wherein the controller turns on the heater immediately when a target minimum temperature of the second preheating lowering section is reached.

10. An operating method of an aerosol generating device, the method comprising:
heating a cigarette by a heater;
measuring a temperature of the heater by a temperature sensor;
calculating a temperature rise time of the cigarette by using the temperature sensor and comparing the calculated temperature rise time with a preset threshold value to determine a humidity state of the cigarette; and
operating the heater with a temperature profile corresponding to the determined humidity state of the cigarette,
wherein the determining of the humidity state of the cigarette comprises determining the cigarette as a regular cigarette when the temperature rise time is less than the threshold value, and determining the cigarette as an over-wet cigarette when the temperature rise time is at the threshold value or more, and
the operating of the heater comprises supplying power to the heater according to a compensation profile when the temperature rise time is at the threshold value or more, the compensation profile comprising a preheating section including a temperature lowering section to condense moisture within the cigarette and a temperature re-rising section to vaporize the condensed moisture.

11. The operating method of claim 11, wherein the operating of the heater comprises supplying power to the heater according to a basic temperature profile when the temperature rise time is less than the threshold value.

12. The operating method of claim 11, wherein the basic temperature profile comprises a first preheating section and a first smoking section,
the compensation profile comprises a second preheating section and a second smoking section,
the first preheating section comprises a first preheating rising section, a first preheating maintaining section, and a first preheating lowering section, and
the second preheating section comprises a second preheating rising section, a second preheating lowering section, a second preheating re-rising section, a second preheating maintaining section, and a second preheating re-lowering section.

13. The operating method of claim 12, wherein the first smoking section comprises a first smoking lowering section and a first smoking maintaining section, and the second smoking section comprises a second smoking lowering section and a second smoking maintaining section.

14. The operating method of claim 13, wherein a target minimum temperature of the second preheating lowering section is less than a target maintenance temperature of the first smoking maintaining section.

15. The operating method of claim 13, wherein a target maximum temperature of the second preheating re-rising section is less than a target maintenance temperature of the first preheating maintaining section.
